(19) United States
(12) Patent Application Publication
(10) Pub. No.: US 2024/0426589 A1
(43) Pub. Date: Dec. 26, 2024

(54) STORAGE DEVICE AND STORAGE METHOD FOR MEASUREMENT PROBE

(71) Applicant: Panasonic Intellectual Property Management Co., Ltd., Osaka (JP)

(72) Inventors: TOSHIO SHIBUTANI, Hyogo (JP); KAZUMI KOBAYASHI, Osaka (JP); TAKANORI FUNABASHI, Hyogo (JP); KEISHI KUBO, Osaka (JP)

(21) Appl. No.: 18/826,243

(22) Filed: Sep. 6, 2024

Related U.S. Application Data
(63) Continuation of application No. PCT/JP2022/040121, filed on Oct. 27, 2022.

(30) Foreign Application Priority Data
Mar. 23, 2022 (JP) 2022-047392

(51) Int. Cl. G01B 5/016; F16C 32/06

(52) U.S. Cl. CPC G01B 5/016; F16C 32/0614

(57) ABSTRACT

A storage device stores a measurement probe used in a profilometer. The measurement probe includes an air bearing configured such that a stylus to be brought into contact with a measurement object is movable. The storage device includes a storage mechanism for storing the measurement probe, and an air supply mechanism configured to continuously supply air to the air bearing when the measurement probe is stored in the storage mechanism.

### TECHNICAL FIELD

The present invention relates to a storage device for a contact type shape measurement probe used in a three-dimensional profilometer that obtains position information of a surface to be measured of an optical component, a mold, or the like.

### BACKGROUND ART

As a method for measuring a surface shape having an aspherical shape of an optical component, a mold or the like with high accuracy, use of a three-dimensional profilometer is widely known. In general, a three-dimensional profilometer including a contact type measurement probe moves the measurement probe along a surface of an object to be measured while bringing a tip of the measurement probe into contact with the object to be measured, and measures a surface shape of the object to be measured from a positional relationship between the measurement probe and a reference surface. As one of such a profilometer, there is a three-dimensional profilometer employing a laser length measuring instrument and a reference flat mirror.

There is a conventional three-dimensional profilometer in which two probes are provided to measure a shape (see, for example, PTL 1).

### CITATION LIST

### Patent Literature

PTL 1: Unexamined Japanese Patent Publication No. 2012-78344

### SUMMARY OF THE INVENTION

However, in the conventional configuration, an upper surface probe and a side surface probe are installed at positions shifted in an X direction. The X position with respect to the measurement object is different on an X-Y stage between the measurement with the upper surface probe and the measurement with the side surface probe, and the measurement takes place. During the measurement with the upper surface probe, the side surface probe needs to be retracted from the measurement area, and during the measurement with the side surface probe, the upper surface probe needs to be retracted from the measurement area. As a result, when the measurement sample is large in the X-Y direction, there is a problem that the device increases in size and cost.

Therefore, by employing a single chuck portion for the probe, a replaceable upper surface probe, and a replaceable side surface probe, the cost of the device as a whole can be reduced although the time and effort for probe replacement are increased.

However, when the replaceable measurement probe of the air bearing type is employed, the following problems occur. During storage of the measurement probe, a cooling effect due to adiabatic expansion when air is released into the atmosphere at the tip does not occur as compared with the time of use at which air is supplied to the air bearing. For this reason, a temperature rise occurs and thermal expansion occurs at the tip of the probe, whereby continuous deformation of the tip occurs during measurement, and measurement accuracy on the order of 0.1 μm cannot be maintained.

The present invention solves the conventional problem, and an object thereof is to provide a storage device and a storage method for enabling measurement accuracy to be maintained for a measurement probe with an air bearing.

According to one aspect of the present invention, in a storage device for a measurement probe used in a profilometer, the measurement probe includes an air bearing configured such that a stylus to be brought into contact with a measurement object is movable, and the storage device includes a storage mechanism for storing the measurement probe, and an air supply mechanism configured to continuously supply air to the air bearing when the measurement probe is stored in the storage mechanism.

According to this configuration, even when the measurement probe is stored without being used, air is continuously supplied to the air bearing by the air supply mechanism. As a result, similarly to the time of use, air is released from the air bearing to the atmosphere, adiabatic expansion occurs, and a cooled state is maintained. Therefore, temperature rise during storage can be prevented, the length from the microslider to the stylus of the measurement probe can be maintained constant, and highly accurate measurement can be performed.

According to the present invention, it is possible to suppress the temperature rise of the measurement probe during storage, and to realize highly accurate measurement.

### BRIEF DESCRIPTION OF THE DRAWINGS

FIG. 1 illustrates a schematic configuration of a profilometer according to an exemplary embodiment.

FIG. 2 illustrates a configuration of a Z-axis stage in the profilometer in FIG. 1.

FIG. 3 illustrates a state of the upper surface measurement probe during measurement.

FIG. 4 illustrates a state of the upper surface measurement probe during storage.

FIG. 5 illustrates another example of a state of the upper surface measurement probe during storage.

FIG. 6 illustrates a state of the side surface measurement probe during measurement.

FIG. 7 illustrates a state of the side surface measurement probe during storage.

Parts (a) and (b) of FIG. 8 are diagrams illustrating a procedure for replacing the upper surface measurement probe.

Parts (a) and (b) of FIG. 9 are diagrams illustrating a procedure for replacing the upper surface measurement probe.

Parts (a) and (b) of FIG. 10 are diagrams illustrating a procedure for replacing the upper surface measurement probe.

FIG. 11 is a diagram illustrating a procedure for replacing the upper surface measurement probe.

Parts (a) and (b) of FIG. 12 are diagrams illustrating a procedure for replacing the side surface measurement probe.

Parts (a) and (b) of FIG. 13 are diagrams illustrating a procedure for replacing the side surface measurement probe.

FIG. 14 is a diagram illustrating a procedure for replacing the side surface measurement probe.

### DESCRIPTION OF EMBODIMENT

Hereinafter, an exemplary embodiment of the present invention will be described with reference to the drawings.

### EXEMPLARY EMBODIMENT

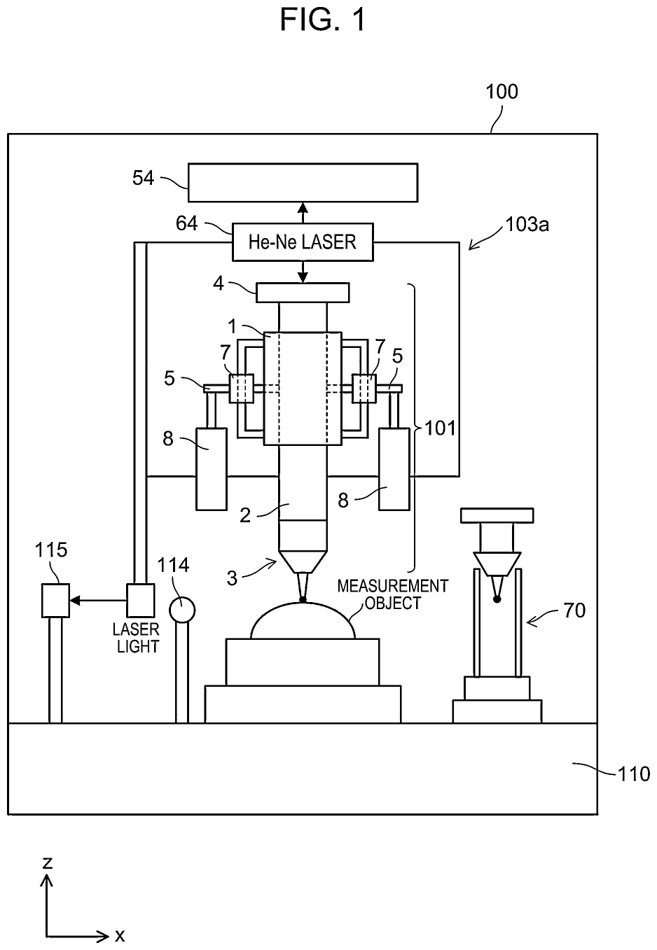

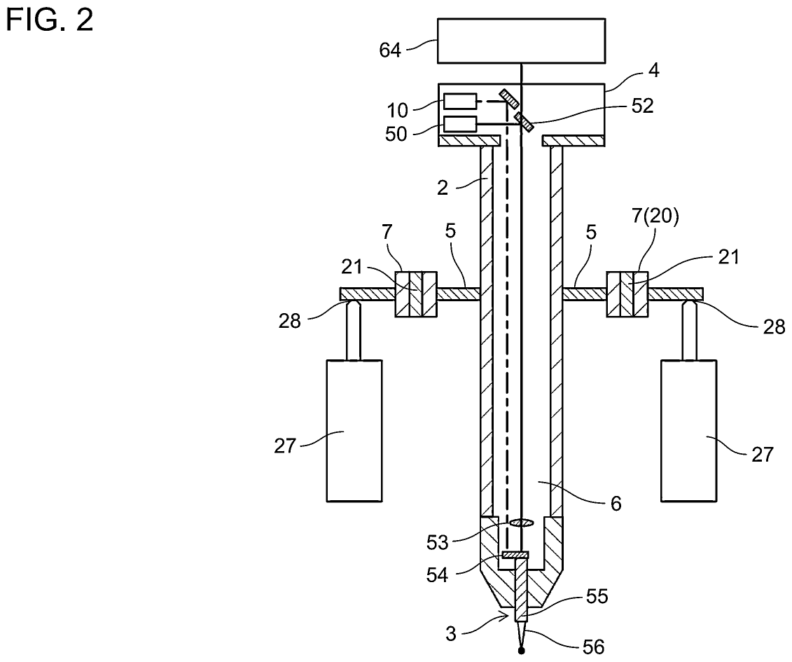

FIG. 1 is a diagram illustrating a schematic configuration of a profilometer according to an exemplary embodiment. Profilometer 100 illustrated in FIG. 1 is a device that measures a three-dimensional shape of a measurement object using an upper surface measurement probe (simply referred to as an upper surface probe as appropriate) and a side surface measurement probe (simply referred to as a side surface probe as appropriate). FIG. 2 is a diagram illustrating a configuration of Z-axis stage 101.

Profilometer 100 includes an X-Y stage (not illustrated), Z-axis stage 101, and a controller (not illustrated). The X-Y stage is disposed on surface plate 110 so as to be movable in the X-Y axis direction, and enables measurement unit 103a to move in the X-Y axis direction. Z-axis stage 101 is supported on surface plate 110 so as to be movable in the Z-axis direction, that is, the vertical direction (vertical direction), and supports probe 3 to be brought into contact with the measurement surface of the measurement object at the lower end to vertically move probe 3. The controller is connected to focus optical system 4, the X-Y stage, Z-axis stage 101, He—Ne laser 64, and the like, and controls operation of each component to control the three-dimensional shape measurement operation. At this time, the controller controls Z-axis stage 101 so that the contact force in the Z direction by probe 3 becomes constant.

An X-axis length-measuring laser light is emitted from measurement unit 103a to X-axis direction mirror 115, and a Y-axis length-measuring laser light is emitted to a Y-axis direction mirror (not illustrated). Probe 3 is brought into contact with a measurement object while measurement unit 103a is moved in the X-axis direction and the Y-axis direction by the X-Y stage. The movement of probe 3 is detected by an optical system connected to Z-axis stage 101, and the three-dimensional shape of the measurement object is measured.

Therefore, profilometer 100 moves the relative position between the measurement surface of the measurement object and probe 3 in the X-Y-Z-direction by the X-Y-stage that moves the measurement surface of probe 3 in the X-Y-Z directions and Z-axis stage 101 that moves probe 3 in the Z-direction.

In addition to probe 3 and focus optical system 4, Z-axis stage 101 includes air slider outer frame 1, air slider hollow shaft 2, two support arms 5, two drivers 7, two support units 8, and the like.

Focus optical system 4 includes at least He—Ne laser 64, and is provided on air slider hollow shaft 2. As illustrated in FIG. 2, focus optical system 4 is substantially composed of He—Ne laser 64, semiconductor laser optical system 50, dichroic mirror 52, collimator lens 53, and mirror 54. Semiconductor laser optical system 50 and dichroic mirror 52 are disposed at the upper end of air slider hollow shaft 2. Collimator lens 53 and mirror 54 are disposed at the lower end of air slider hollow shaft 2. Mirror 54 is fixed to an upper end of stylus 56 supported by microslider 55 of probe 3.

Further, inclined optical system 10 is provided in air slider hollow shaft 2 so as to be annexed in the space of the optical path of focus optical system 4. Inclined optical system 10 includes a semiconductor laser (not illustrated) for the inclined optical system and mirror 54. When microslider 55 installed in a lens barrel of probe 3 is inclined, the light emitted from inclined optical system 10 is reflected by mirror 54 on the upper surface of microslider 55, and this change is detected to correct the inclination.

Air slider hollow shaft 2 is a vertically long rectangular parallelepiped cylindrical member, and functions as a Z-axis drive shaft of Z-axis stage 101. In air slider hollow shaft 2, focus optical system 4 is disposed at an upper end, and probe 3 is disposed at a lower end. Through hole 6 is provided at the center of air slider hollow shaft 2, and an optical path connecting focus optical system 4 with mirror 54 at the upper end of probe 3 is formed in through hole 6. As an example, air slider hollow shaft 2 is made of a heat insulating material such as ceramic. For example, even when the heat of coil 21 to be described later is transmitted via support arms 5, the heat is insulated by the heat insulating material, and the heat is not transmitted to air slider hollow shaft 2. This makes it possible to prevent air slider hollow shaft 2 from being bent by heat.

Driver 7 is disposed at a position near air slider hollow shaft 2 of each support arm 5 so as to be symmetric with respect to the central axis of air slider hollow shaft 2. Driver 7 can drive air slider hollow shaft 2 in the axial direction via two support arms 5 with respect to air slider outer frame 1. A pair of the drivers 7 are symmetrical with respect to the central axis of air slider hollow shaft 2. Here, each driver 7 is constituted by linear motor 20 which is an example of an actuator. As illustrated in FIG. 2, air cylinder 27 is connected to the distal end of each support arm 5 via air pad 28.

Linear motor 20 includes coil 21 formed in a rectangular frame shape and a magnet (not illustrated), and is driven and controlled by the controller. Coil 21 is disposed at a position in the vicinity of air slider hollow shaft 2 of each support arm 5, and support arm 5 is connected to the center portion of coil 21 in the axial direction. Coil 21 is fitted to the outside of a center yoke (not illustrated) and is freely movable in the vertical direction. A predetermined drive current is applied to coil 21, thereby moving air slider hollow shaft 2 in the vertical direction with respect to the center yoke on the fixed side. As described above, linear motor 20 used in the present exemplary embodiment is a movable coil type in which coil 21 is supported by support arm 5 and the magnet is fixed to air slider outer frame 1. Therefore, by using the relatively heavy magnet on the fixed side and using the relatively light coil on the movable side, the weight of the movable portion of linear motor 20 can be reduced as a whole. In addition, the rotational moment can also be suppressed, the power consumption applied to the motor can be suppressed, and the thermal deformation can be suppressed.

Mirror 54 for measuring the height in the Z direction is provided on the upper surface side of measurement unit 103a. The height of probe 3 in the Z direction is directly measured by measuring the position of the surface of mirror 54 using a frequency stabilizing laser having a wavelength of 633 nm as a scale. The wavelength change rate of the frequency stabilizing laser due to the temperature change of the air, that is, the linear expansion coefficient is about 1/20 to 1/10 smaller than the linear expansion coefficient of aluminum, iron, or the like constituting the mechanical part of measurement unit 103a. Therefore, even when the mechanical part constituting measurement unit 103a is thermally deformed due to a temperature change, it is possible to suppress a measurement error caused by a change in the measurement value due to the temperature.

In addition, profilometer 100 includes storage device 70 that stores a measurement probe. Although simplified in FIG. 1, storage device 70 includes a storage mechanism for storing the measurement probe, and an air supply mechanism configured to continuously supply air to the air bearing when the measurement probe is stored in the storage mechanism. As illustrated in FIG. 1, the height of the tip position of the stylus of the probe stored in the storage device 70 may be adjusted to the height of the tip position of the stylus of probe 3 for measurement. As a result, it is possible to suppress a temperature change between the styluses at the time of measurement and at the time of storage.

### <Upper Surface Measurement Probe>

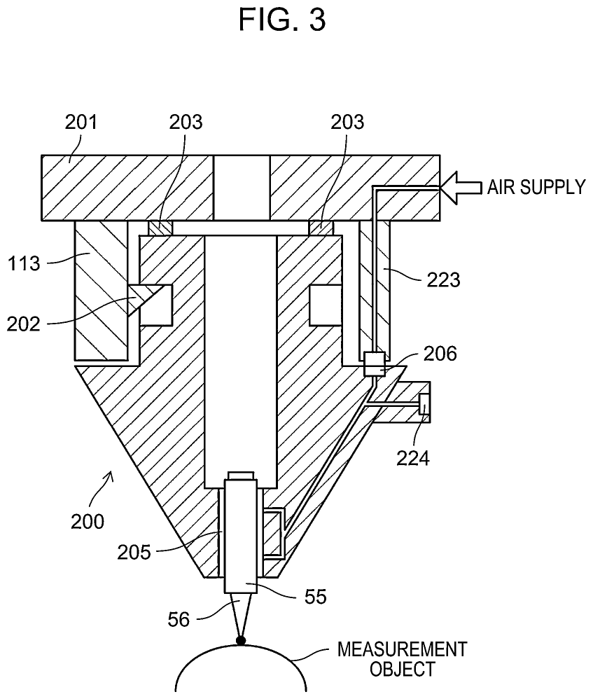

FIG. 3 illustrates a state of upper surface probe 200 during measurement. Measurement chuck 201 provided in the device body includes probe holding mechanism 113 having holding claw 202. Holding claw 202 is configured to be opened and closed by an air cylinder (not illustrated). Upper surface probe 200 is positioned by being pressed upward against positioning pin 203 of measurement chuck 201, and is held by measurement chuck 201 when holding claw 202 is closed.

Upper surface probe 200 includes air bearing 205 configured to allow stylus 56 to move in the Z direction. Micro air slider 55 made of an aluminum member is provided in air bearing 205, and stylus 56 made of aluminum is attached to a tip of the micro air slider. Air coupler 223 extending downward from measurement chuck 201 is connected to air joint 206 of upper surface probe 200. An air supply path is thus formed, and air is supplied from measurement chuck 201 to air bearing 205.

Here, the flow rate of the air supplied to air bearing 205 is as low as a range from 0.4 NL/min to 0.6 NL/min, for example, and the air supplied to the device slowly travels along the air supply path. Therefore, the air supplied from air coupler 223 conforms to the temperature of upper surface probe 200, and is the same as the upper surface probe immediately before being released to the atmosphere through air bearing 205.

The supplied air passes through a fine gap of around 10 μm of air bearing 205, and is released to the atmosphere from the upper circular air protrusion and the lower circular air protrusion. That is, the pressure of the compressed air decreases due to rapid release to the atmosphere, and the amount of heat of the divergent air is deprived due to adiabatic expansion, and a minute temperature decrease of less than or equal to 1° C. occurs around micro air slider 55. If the lengths of micro air slider 55 and stylus 56 in the Z direction continue to change due to the temperature decrease, a measurement error occurs. However, since upper surface probe 200 is exposed to a measured environmental temperature of a peripheral portion of installation and a heat quantity is supplied by air of the peripheral portion, the temperature does not continue to decrease and a constant temperature is maintained. Therefore, highly accurate measurement can be performed.

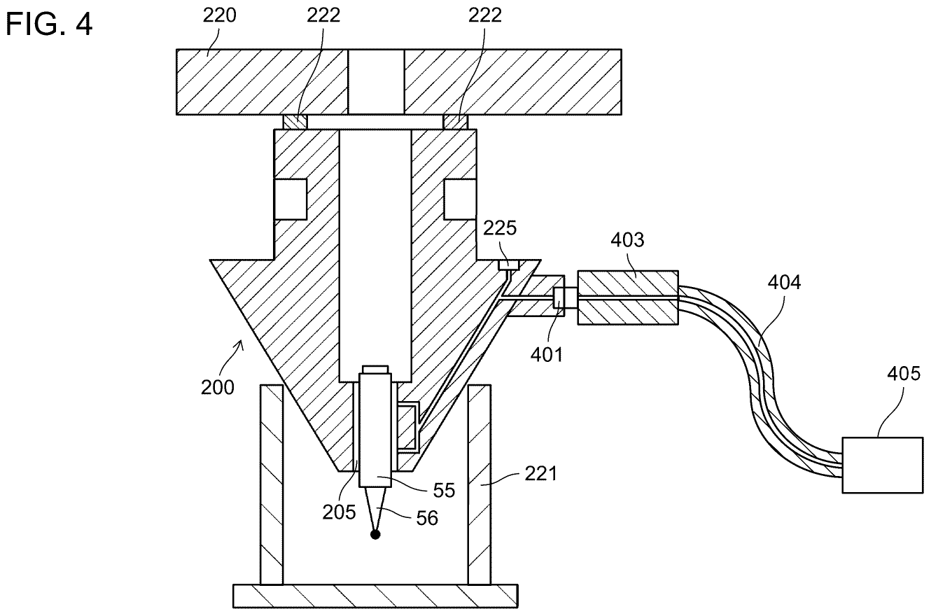

FIG. 4 illustrates a state of upper surface probe 200 during storage. Upper surface probe 200 is stored by storage base 221 and storage chuck 220. In the present exemplary embodiment, storage base 221 and storage chuck 220 constitute the storage mechanism. Upper surface probe 200 is biased upward from storage base 221, pressed against storage chuck 220, and positioned by positioning pin 222.

Here, in the present exemplary embodiment, upper surface probe 200 is provided with air joint 401 on the side separately from air joint 206. As illustrated in FIG. 4, when upper surface probe 200 is stored, air coupler 403 is joined to air joint 401. An air supply path is thus formed, and air is supplied from air supply source 405 to air bearing 205 via heat insulating tube 404 (an example of the heat insulating structure) and air coupler 403. In the present exemplary embodiment, air supply source 405, heat insulating tube 404, and air coupler 403 constitute an air supply mechanism. Air supply source 405 is, for example, an air compressor. Since the air supply mechanism includes heat insulating tube 404, it is possible to make it difficult to transfer heat around the air supply mechanism to the air passing through heat insulating tube 404.

That is, at the time of storage as well as at the time of measurement, the supplied air passes through the fine gap of air bearing 205, the pressure decreases due to rapid release to the atmosphere, and the heat quantity is deprived due to adiabatic expansion, and thus, a minute temperature decrease occurs around micro air slider 55. With this configuration, a temperature environment similar to that at the time of measurement is maintained, and micro air slider 55 and stylus 56 are maintained and stored with a constant length without changing the length.

At the time of measurement, stop valve 224 provided in air joint 401 seals air joint 401 with an internal spring or the like so that air is not released to the atmosphere side. At the time of storage, stop valve 225 provided in air joint 206 seals air joint 206 with an internal spring or the like so that air is not released to the atmosphere side.

When micro air slider 55 is made of a material having a small linear expansion coefficient such as ceramic, the measurement can be performed with higher accuracy. However, it is not easy to process cylindrical micro air slider 55 with high accuracy, and the cost increases. In addition, when upper surface probe 200 is brought into contact with a measurement object or the like due to an operation error, the upper surface probe is easily broken and low in handleability considering a repair cost and a repair period. On the other hand, aluminum has good processability, can be processed with high accuracy, and there is no risk of cracking. In addition, since stylus 56 also needs to be periodically replaced, it is desirable to include aluminum in order to suppress the running cost.

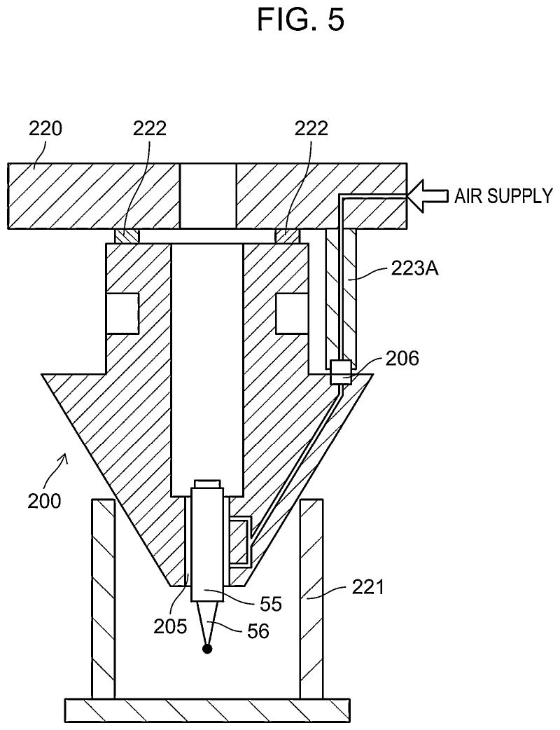

FIG. 5 is another example of the state of upper surface probe 200 at the time of storage. In the example of FIG. 5, upper surface probe 200 is not provided with air joint 401 on the side. As illustrated in FIG. 5, storage chuck 220 includes air coupler 223A extending downward. When upper surface probe 200 is stored, air coupler 223A is joined to air joint 206. An air supply path is thus formed, and air is supplied from air coupler 223A to air bearing 205.

As illustrated in FIG. 5, the air supply during storage may be performed via air joint 206 on the upper side of upper surface probe 200, similarly to the air supply during measurement. Air joint 206 is located away from the central axis of upper surface probe 200. Alternatively, another air joint may be provided, for example, around upper surface probe 200 abutting on positioning pin 222, and air may be supplied through the air joint during storage. In this case, the air joint is near the central portion at a position away from the central axis of upper surface probe 200.

### <Side Surface Measurement Probe>

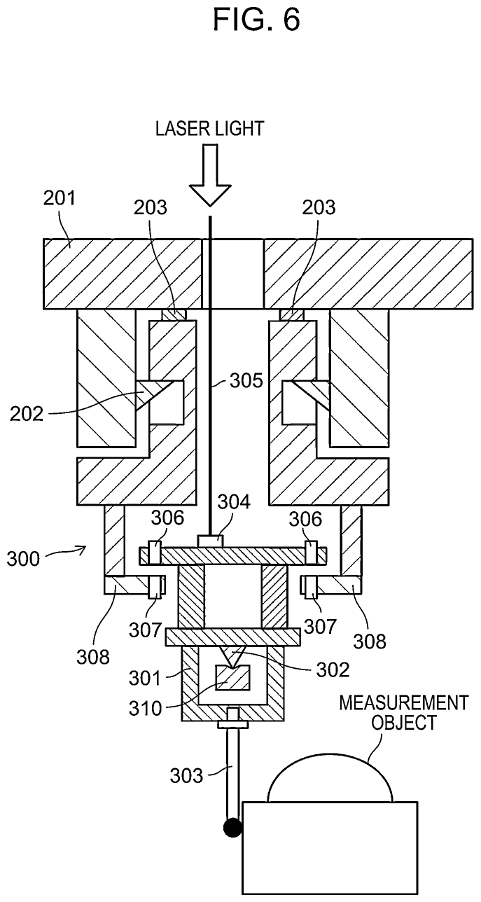

FIG. 6 illustrates a state of side surface probe 300 during measurement. Side surface probe 300 measures the shape of the measurement object from the X-Y direction. Measurement chuck 201 provided in the device body includes holding claw 202 configured to be opened and closed by an air cylinder (not illustrated). Side surface probe 300 is positioned by being pressed upward against positioning pin 203 of measurement chuck 201, and is held by measurement chuck 201 by closing holding claw 202.

Side surface movable part 301 is supported by fulcrum 302 at a recess of Y-direction support column 310, and is rotatable and movable in α (around the X axis) and β (around the Y axis). Y-direction support column 310 is fixed to side surface probe 300. Side surface stylus 303 that comes into contact with the measurement surface is set at a tip of side surface movable part 301. When side surface stylus 303 comes into contact with the measurement surface in the X-Y direction, side surface movable part 301 performs a rotational movement in the αβ direction with fulcrum 302 as a rotation center.

The position of fulcrum 302 is maintained in a state in which there is no heat source such as an air supply source or an actuator around the fulcrum and the fulcrum is accustomed to the surrounding temperature environment. Therefore, the X-Y position of fulcrum 302 does not change, and highly accurate position measurement in the X-Y direction can be performed with reference to fulcrum 302.

Similarly to upper surface probe 200, inclined optical system 10 is used for detecting the inclination of the side surface. The laser light emitted from inclined optical system 10 passes through inclination measuring optical path 305 and enters side surface mirror 304 provided at the upper end of side surface movable part 301. The light reflected by side surface mirror 304 passes through inclination measuring optical path 305 again, and is detected by inclined optical system 10.

Movable magnet 306 is provided at the upper end of side surface movable part 301, and fixed magnet 307 is provided in the housing of side surface probe 300 at a position paired with the movable magnet. Fixed magnet 307 is movable in the X-Y direction by X-Y position fine adjustment mechanism 308.

The X-Y position of fixed magnet 307 is adjusted by X-Y position fine adjustment mechanism 308, and the α and β rotations of side surface movable part 301 are adjusted so that the emitted laser light returns to the central portion of inclined optical system 10. This adjustment is performed in a state where the device is powered on and side surface probe 300 is attached to the device body. After the adjustment, the X-Y position adjusted by X-Y position fine adjustment mechanism 308 is locked.

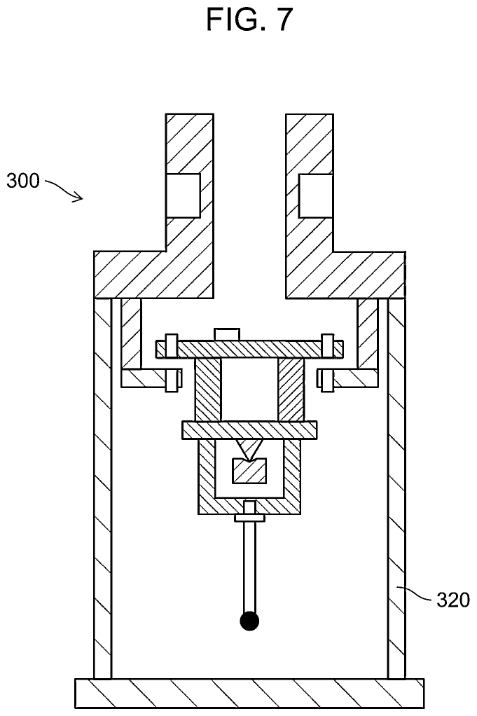

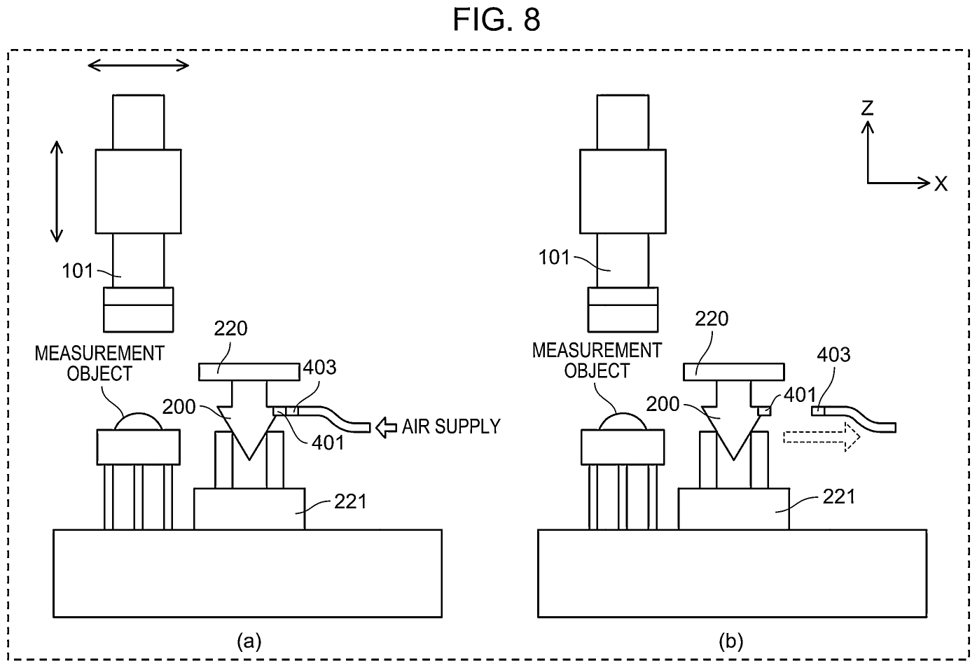

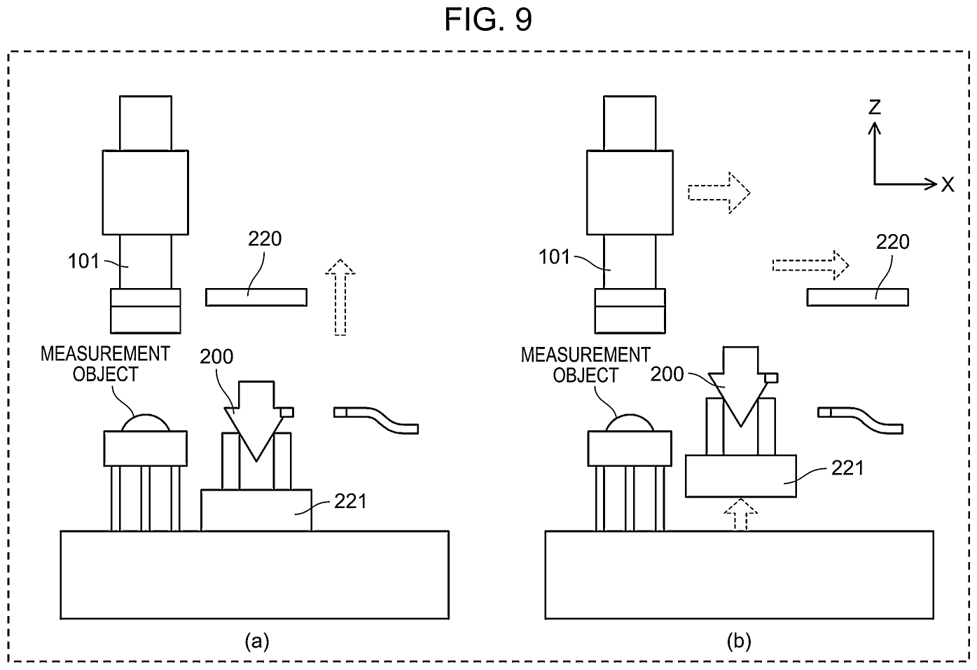

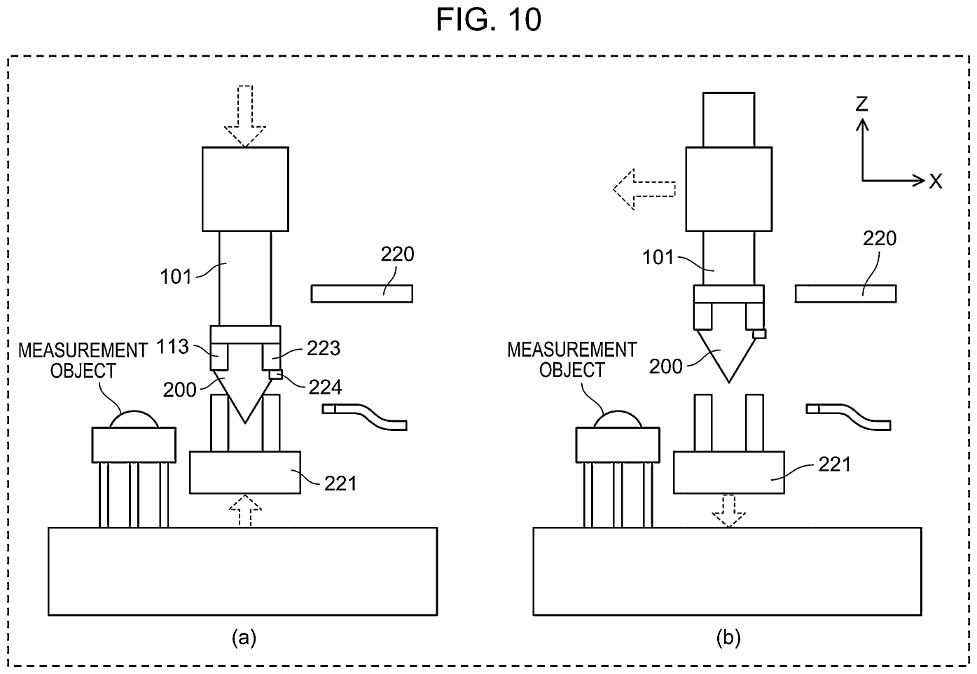

FIG. 7 illustrates a state of side surface probe 300 during storage. Side surface probe 300 is placed and held on storage base 320. During storage, there is no need to supply air, drive an actuator, or the like, and storage is possible in a thermally stable state.

### <Probe Replacement Procedure>

### (Upper Surface Probe Replacement)

A procedure for replacing the upper surface probe will be described with reference to FIGS. 8 to 11. Here, upper surface probe 200 illustrated in FIGS. 3 and 4 is used.

As illustrated in part (a) of FIG. 8, upper surface probe 200 is stored in storage base 221. Upper surface probe 200 is fixed to storage base 221 by storage chuck 220. At this time, in upper surface probe 200, air coupler 403 is joined to air joint 401, and a state in which air is supplied to air bearing 205 is maintained. This makes it possible to maintain a constant decrease in the amount of heat due to adiabatic expansion of the air released to the atmosphere.

As illustrated in part (b) of FIG. 8, air coupler 403 is moved rightward in the drawing and removed from air joint 401. As a result, the air supply path to air bearing 205 is disconnected, and upper surface probe 200 becomes movable.

As illustrated in part (a) of FIG. 9, storage chuck 220 is moved upward. As shown in part (b) of FIG. 9, storage chuck 220 is moved in the right direction in the drawing to raise storage base 221. Then, Z-axis stage 101 attached to the X-Y stage (not illustrated) is moved to a removal position of upper surface probe 200.

As shown in part (a) of FIG. 10, Z-axis stage 101 is moved downward, and holding claw 202 (see FIG. 3) of probe holding mechanism 113 is hooked on upper surface probe 200. At this time, it is desirable that the X-Y-Z positions and the rotational position around the X-Y-Z axes are positioned using three positioning pins, by the kinematic structure in which the V-shaped groove is formed. Air coupler 223 is coupled to air joint 206 (see FIG. 3) of upper surface probe 200. An air supply path is thus formed, and air is supplied to air bearing 205. Stop valve 224 provided on the side of upper surface probe 200 seals so that air is not released to the atmosphere.

As illustrated in part (b) of FIG. 10, Z-axis stage 101 is moved upward to raise upper surface probe 200. Thereafter, storage base 221 is lowered, and Z-axis stage 101 is further moved in the left direction in the drawing. A cover (not illustrated) is put from above to store storage base 221.

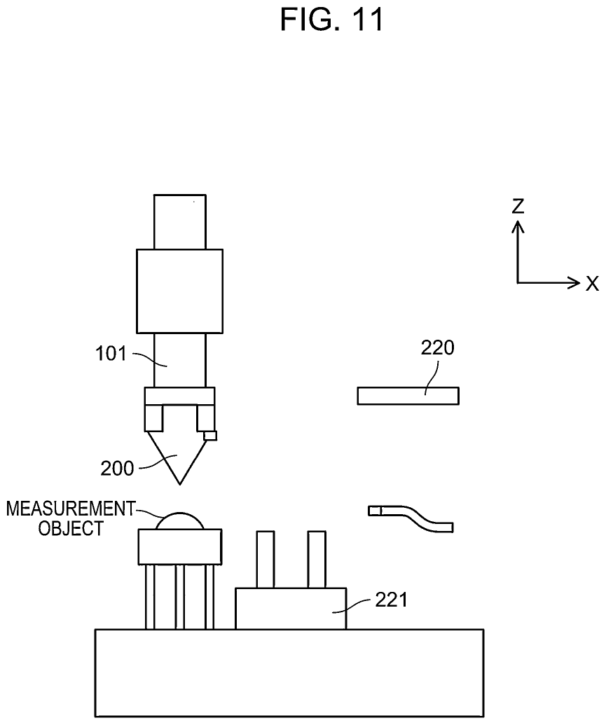

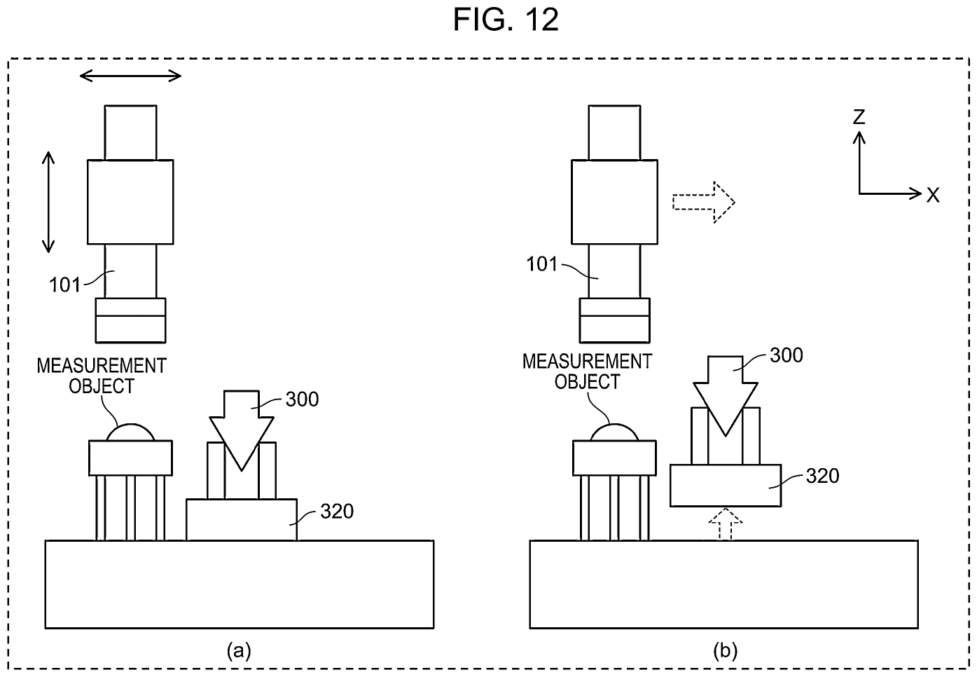

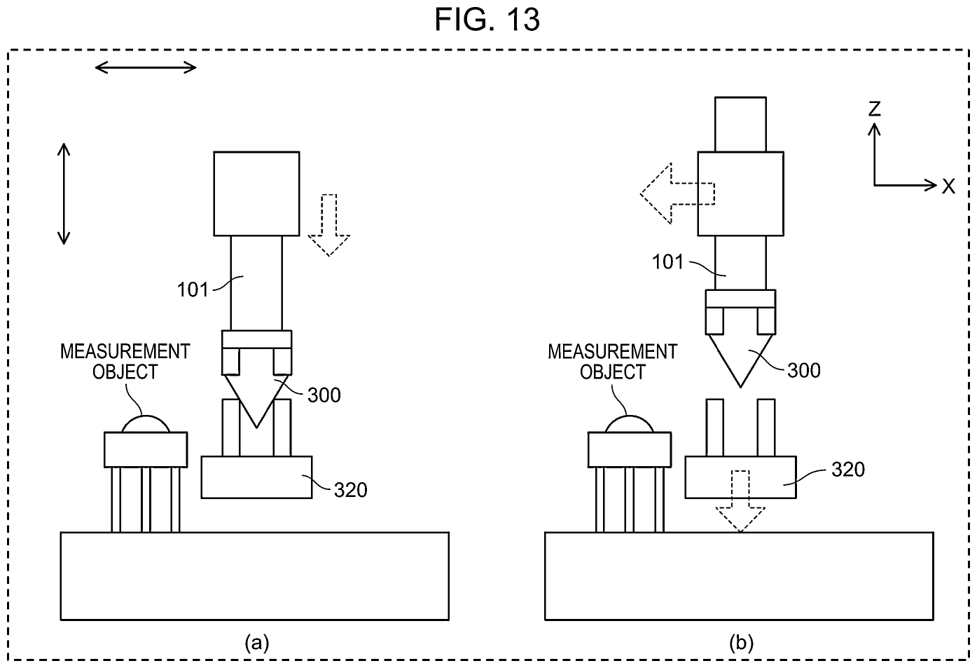

As illustrated in FIG. 11, the surface shape of the measurement object is measured by upper surface probe 200 attached to Z-axis stage 101. A servo is applied in the Z direction by linear motor 20 so that the measurement force when stylus 56 comes into contact with the measurement object becomes constant (this state is referred to as servo on, and stopping the servo from the servo on state is referred to as servo off). In the servo on state, scanning is performed in the X-Y direction to measure the laser-measured length of the X-Y-Z axes. Acquired measured data point sequence A of the X-Y-Z coordinate is stored.

Note that after replacement of upper surface probe 200, the tip position of stylus 56 does not maintain reproducibility with accuracy of micrometer order or less, and is not at an accurate position. For this reason, a micron-order positional deviation occurs in the measurement data, and the measurement accuracy deteriorates. In order to prevent this, before the measurement of the measurement object, fixed reference sphere 114 (see FIG. 1) provided in a state of being fixed on surface plate 110 is scanned from above in the X-Y direction, and center coordinate A of fixed reference sphere 114 is calculated from the measurement data and stored in the memory.

After the measurement, upper surface probe 200 is returned to storage base 221 by a procedure reverse to the procedure described above. Storage chuck 220 is transferred to above upper surface probe 200. Positioning with positioning pin 222 joins air coupler 403 to air joint 401 on the side of upper surface probe 200. Air supply is started to supply air to air bearing 205, and a temperature environment similar to that during measurement is maintained during storage.

When the upper surface probe illustrated in FIG. 5 is used, the method of air supply during storage is different. However, other than that, the probe replacement may be performed in the same procedure.

### (Side Surface Probe Replacement)

A replacement procedure of the side surface probe will be described with reference to FIGS. 12 to 14.

As illustrated in part (a) of FIG. 12, side surface probe 300 is installed on storage base 320. As illustrated in part (b) of FIG. 12, storage base 320 is raised. Then, Z-axis stage 101 attached to the X-Y stage (not illustrated) is moved to the removal position of side surface probe 300.

As shown in part (a) of FIG. 13, Z-axis stage 101 is moved downward, and holding claw 202 (see FIG. 6) is hooked on side surface probe 300. At this time, it is desirable that the X-Y-Z positions and the rotational position around the X-Y-Z axes are positioned using three positioning pins, by the kinematic structure in which the V-shaped groove is formed.

As illustrated in part (b) of FIG. 13, Z-axis stage 101 is moved upward to raise side surface probe 300. Thereafter, storage base 320 is lowered, and Z-axis stage 101 is further moved in the left direction in the drawing. A cover (not illustrated) is put from above to store storage base 320.

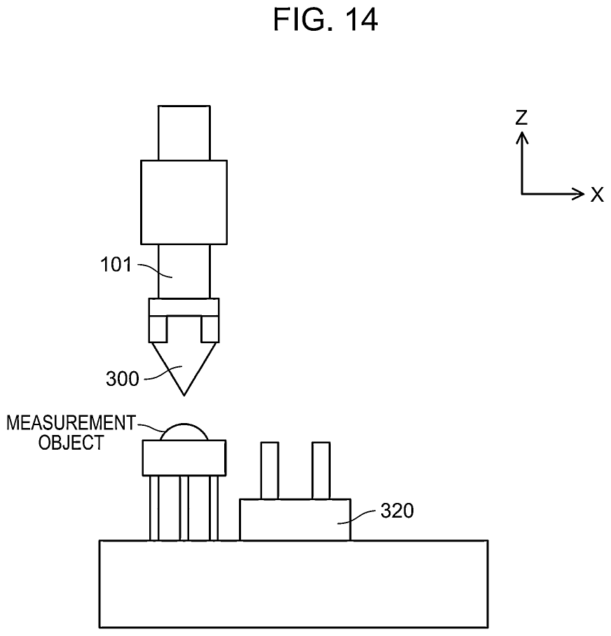

As illustrated in FIG. 14, the side surface shape of the measurement object is measured by side surface probe 300 attached to Z-axis stage 101. A servo is applied in the X-Y direction by linear motor (not illustrated) so that the measurement force when side surface stylus 306 comes into contact with the measurement object in the X-Y direction becomes constant (this state is referred to as X-Y servo on, and stopping the servo from the servo on state is referred to as X-Y servo off). In the X-Y servo on state, scanning is performed in the X-Y direction to measure the laser-measured length of the X-Y-Z axes. The acquired measured data point sequence B of the X-Y-Z coordinate is stored.

Note that after replacement of side surface probe 300, the tip position of side surface stylus 303 does not maintain reproducibility with accuracy of micrometer order or less, and is not at an accurate position. For this reason, a micron-order positional deviation occurs in the measurement data, and the measurement accuracy deteriorates. In order to prevent this, before the measurement of the measurement object, fixed reference sphere 114 provided in a state of being fixed on surface plate 110 is scanned so as to rotate in the circumferential direction on the X-Y plane, for example, and center coordinate B of fixed reference sphere 114 is calculated from the measurement data and stored in the memory.

After the measurement, side surface probe 300 is returned to storage base 320 by a procedure reverse to the procedure described above.

(Data Synthesis after Measurement)

After the measurement, measured data point sequence A acquired using upper surface probe 200 and measured data point sequence B acquired using side surface probe 300 are synthesized to acquire three-dimensional shape data of the measurement object. At this time, the coordinates of measured data point sequence A and measured data point sequence B are converted so that center coordinate A obtained by upper surface probe 200 and center coordinate B obtained by side surface probe 300 coincide with each other, and three-dimensional shape data is generated.

By such measurement, the three-dimensional shape can be measured with ultra-high accuracy in a range from 1 nm to 100 nm on both the upper surface and the side surface of the measurement object.

### INDUSTRIAL APPLICABILITY

The present invention is useful for realizing highly accurate three-dimensional measurement in shape measurement using a measurement probe with an air bearing.

### REFERENCE MARKS IN THE DRAWINGS

56 stylus
70 storage device
100 profilometer
200 upper surface probe
220 storage chuck
221 storage base
205 air bearing
403 air coupler
404 heat insulating tube
405 air supply source

1. A storage device for a measurement probe used in a profilometer, the measurement probe including an air bearing configured to enable a stylus to be brought into contact with a measurement object to move, the storage device comprising:
a storage mechanism for storing the measurement probe; and
an air supply mechanism configured to continuously supply air to the air bearing when the measurement probe is stored in the storage mechanism.

2. The storage device for a measurement probe according to claim 1, wherein the air supply mechanism is configured to supply air from a side surface of the measurement probe.

3. The storage device for a measurement probe according to claim 1, wherein the air supply mechanism includes
a heat insulating structure and
an air supply source configured to supply air to the air bearing via the heat insulating structure.

4. A method of storing a measurement probe used in a profilometer, the measurement probe including an air bearing configured to enable a stylus to be brought into contact with a measurement object to move, the method comprising:
storing the measurement probe in a storage mechanism; and
with respect to the measurement probe stored in the storage mechanism, continuously supplying air to the air bearing by an air supply mechanism.
